(19) United States
(12) Patent Application Publication
(10) Pub. No.: US 2012/0089781 A1
(43) Pub. Date: Apr. 12, 2012

(54) MECHANISM FOR RETRIEVING COMPRESSED DATA FROM A STORAGE CLOUD

(76) Inventors: Sandeep Ranade, San Jose, CA (US); Allen Samuels, San Jose, CA (US); Shiva Kalyani Ankam, San Jose, CA (US)

(21) Appl. No.: 12/902,071

(22) Filed: Oct. 11, 2010

(51) Int. Cl. G06F 12/08; G06F 12/00

(52) U.S. Cl. 711/118; 711/154; 711/E12.001; 711/E12.017

(57) ABSTRACT

A cloud storage appliance receives one or more read requests for data stored in a storage cloud. The cloud storage appliance determines, for a time period, a total amount of bandwidth that will be used to retrieve the requested data from the storage cloud. The cloud storage appliance then determines an amount of remaining bandwidth for the time period. The cloud storage appliance retrieves the requested data from the storage cloud in the time period to satisfy the one or more read requests. The cloud storage appliance additionally retrieves a quantity of unrequested data from the storage cloud in the time period, wherein the quantity of retrieved unrequested data is based on the amount of remaining bandwidth for the time period.

### TECHNICAL FIELD

Embodiments of the present invention relate to data storage, and more specifically to a method and apparatus for retrieving compressed data from a storage cloud.

### BACKGROUND

Enterprises typically include expensive collections of network storage, including storage area network (SAN) products and network attached storage (NAS) products. As an enterprise grows, the amount of storage that the enterprise must maintain also grows. Thus, enterprises are continually purchasing new storage equipment to meet their growing storage needs. However, such storage equipment is typically very costly. Moreover, an enterprise has to predict how much storage capacity will be needed, and plan accordingly.

Cloud storage has recently developed as a storage option. Cloud storage is a service in which storage resources are provided on an as needed basis, typically over the internet. With cloud storage, a purchaser only pays for the amount of storage that is actually used. Therefore, the purchaser does not have to predict how much storage capacity is necessary. Nor does the purchaser need to make up front capital expenditures for new network storage devices. Thus, cloud storage is typically much cheaper than purchasing network devices and setting up network storage.

Despite the advantages of cloud storage, enterprises are reluctant to adopt cloud storage as a replacement to their network storage systems due to its disadvantages. First, most cloud storage uses completely different semantics and protocols than have been developed for file systems. For example, network storage protocols include common internet file system (CIFS) and network file system (NFS), while protocols used for cloud storage include hypertext transport protocol (HTTP) and simple object access protocol (SOAP). Additionally, cloud storage does not provide any file locking operations, nor does it guarantee immediate consistency between different file versions. Therefore, multiple copies of a file may reside in the cloud, and clients may unknowingly receive old copies. Additionally, storing data to and reading data from the cloud is typically considerably slower than reading from and writing to a local network storage device.

Cloud storage protocols also have different semantics to block-oriented storage, whether network block-storage like iSCSI, or conventional block-storage (e.g., SAN or DAS). Block-storage devices provide atomic reads or writes of a contiguous linear range of fixed-sized blocks. Each such write happens “atomically” with request to subsequent read or write requests. Allowable block ranges for a single block-storage command range from one block up to several thousand blocks. In contrast, cloud-storage objects must each be written or read individually, with no guarantees, or at beast weak guarantees, of consistency of subsequent read requests which read some or all of a sequence of writes to cloud-storage objects. Finally, cloud security models are incompatible with existing enterprise security models. Embodiments of the present invention combine the advantages of network storage devices and the advantages of cloud storage while mitigating the disadvantages of both.

### SUMMARY

Described herein are a method and apparatus for retrieving compressed data from a storage cloud. In one embodiment, a cloud storage appliance receives one or more read requests for data stored in a storage cloud. The cloud storage appliance determines, for a time period, a total amount of bandwidth that will be used to retrieve the requested data from the storage cloud. The cloud storage appliance then determines an amount of remaining bandwidth for the time period. The cloud storage appliance retrieves the requested data from the storage cloud in the time period to satisfy the one or more read requests. In one embodiment, this includes retrieving requested data chunks as well as additional data chunks referenced by the requested data chunks. The cloud storage appliance additionally retrieves a quantity of unrequested data from the storage cloud in the time period, wherein the quantity of retrieved unrequested data is based on the amount of remaining bandwidth for the time period. In one embodiment, the retrieved unrequested data comprises cloud files, where each of the cloud files contains multiple data chunks.

### BRIEF DESCRIPTION OF THE DRAWINGS

The present invention is illustrated by way of example, and not by way of limitation, in the figures of the accompanying drawings and in which:

FIG. 1 illustrates an exemplary network architecture, in which embodiments of the present invention may operate;

FIG. 2 illustrates an exemplary network architecture, in which multiple cloud storage appliances and a cloud storage agent are used at different locations, in accordance with one embodiment of the present invention;

FIG. 3 illustrates a block diagram of a data fetching module, in accordance with one embodiment of the present invention;

FIG. 4 diagrammatically shows a reference tree for a compressed data chunk;

FIG. 5 is a flow diagram illustrating one embodiment of a method for retrieving data from a storage cloud;

FIG. 6 is a flow diagram illustrating another embodiment of a method for retrieving data from a storage cloud;

FIG. 7 is a flow diagram illustrating yet another embodiment of a method for retrieving data from a storage cloud;

FIG. 8 is a flow diagram illustrating still yet another embodiment of a method for retrieving data from a storage cloud; and

FIG. 9 illustrates a diagrammatic representation of a machine in the exemplary form of a computer system within which a set of instructions, for causing the machine to perform any one or more of the methodologies discussed herein, may be executed.

### DETAILED DESCRIPTION

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “retrieving”, “separating”, “placing”, “determining”, “responding”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), etc.

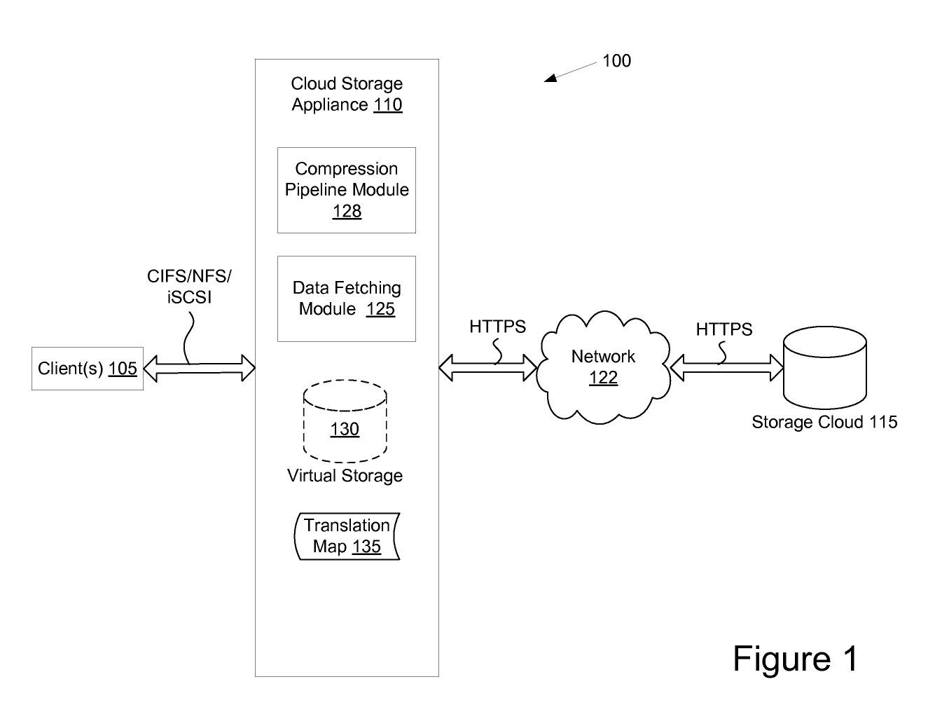

FIG. 1 illustrates an exemplary network architecture 100, in which embodiments of the present invention may operate. The network architecture 100 includes one or more clients 105 connected to a cloud storage appliance 110. The clients 105 may be connected to the cloud storage appliance 110 directly or via a local network (not shown). The network architecture 100 further includes the cloud storage appliance 110 connected to a storage cloud 115 via a network 122, which may be a public network, such as the Internet, a private network, such as a wide area network (WAN), or a combination thereof.

Storage cloud 115 is a dynamically scalable storage provided as a service over a public network (e.g., the Internet) or a private network (e.g., a wide area network (WAN). Some examples of storage clouds include Amazon's® Simple Storage Service (S3), Nirvanix® Storage Delivery Network (SDN), Windows® Live SkyDrive, Ironmountain's® storage cloud, Rackspace® Cloudfiles, AT&T® Synaptic Storage as a Service, Zetta® Enterprise Cloud Storage On Demand, IBM® Smart Business Storage Cloud, and Mosso® Cloud Files. Most storage clouds provide unlimited storage through a simple web services interface (e.g., using standard HTTP commands or SOAP commands). However, most storage clouds 115 are not capable of being interfaced using standard file system protocols such as common internet file system (CIFS), direct access file systems (DAFS), or block-level network storage protocols such as internet small computer systems interface (iSCSI) or network file system (NFS). The storage cloud 115 is an object based store. Data objects stored in the storage cloud 115 may have any size, ranging from a few bytes to the upper size limit allowed by the storage cloud (e.g., 5 GB).

In one embodiment, each of the clients 105 is a standard computing device that is configured to access and store data on network storage. Each client 105 includes a physical hardware platform on which an operating system runs. Examples of clients 105 include desktop computers, laptop computers, tablet computers, netbooks, mobile phones, etc. Different clients 105 may use the same or different operating systems. Examples of operating systems that may run on the clients 105 include various versions of Windows, Mac OS X, Linux, Unix, O/S 2, etc.

Cloud storage appliance 110 may be a computing device such as a desktop computer, rackmount server, etc. Cloud storage appliance 110 may also be a special purpose computing device that includes a processor, memory, storage, and other hardware components, and that is configured to present storage cloud 115 to clients 105 as though the storage cloud 115 was a standard network storage device. In one embodiment, cloud storage appliance 110 is a cluster of computing devices. Cloud storage appliance 110 may include an operating system, such as Windows, Mac OS X, Linux, Unix, O/S 2, etc. Cloud storage appliance 110 may further include a data fetching module 125, a compression pipeline module 128, a virtual storage 130 and a translation map 135. In one embodiment, the cloud storage appliance 110 is a client that runs a software application including the data fetching module 125, compression pipeline module 128, virtual storage 130 and translation map 135.

In one embodiment, clients 105 connect to the cloud storage appliance 110 via standard file systems protocols, such as CIFS or NFS. The cloud storage appliance 110 communicates with the client 105 using CIFS commands, NFS commands, server message block (SMB) commands and/or other file system protocol commands that may be sent using, for example, the internet small computer system interface (iSCSI) or fiber channel. NFS and CIFS, for example, allow files to be shared transparently between machines (e.g., servers, desktops, laptops, etc.). Both are client/server applications that allow a client to view, store and update files on a remote storage as though the files were on the client's local storage.

The cloud storage appliance 110 communicates with the storage cloud 115 using cloud storage protocols such as hypertext transfer protocol (HTTP), hypertext transport protocol over secure socket layer (HTTPS), simple object access protocol (SOAP), representational state transfer (REST), etc. Thus, cloud storage appliance 110 may store data in storage cloud 115 using, for example, common HTTP POST or PUT commands, and may retrieve data using HTTP GET commands. Cloud storage appliance 110 formats each message so that it will be correctly interpreted and acted upon by storage cloud 115.

In a conventional network storage architecture, clients 105 would be connected directly to storage devices, or to a local network (not shown) that includes attached storage devices (and possibly a storage server that provides access to those storage devices). In contrast, the illustrated network architecture 100 does not include any network storage devices attached to a local network. Rather, in one embodiment of the present invention, the clients 105 store all data on the storage cloud 115 via cloud storage appliance 110 as though the storage cloud 115 was network storage of the conventional type.

The cloud storage appliance emulates, for example, a file system stack that is understood by the clients 105, which enables clients 105 to store data to the storage clouds 115 using standard file system semantics (e.g., CIFS or NFS). Therefore, the cloud storage appliance 110 can provide a functional equivalent to traditional file system servers, and thus eliminate any need for traditional file system servers. In one embodiment, the cloud storage appliance 110 provides a cloud storage optimized file system that sits between an existing file system stack of a conventional file system protocol (e.g., NFS or CIFS) and physical storage that includes the storage cloud 115. The cloud storage appliance 110 may also emulate a block-level storage (e.g., that uses iSCSI protocols).

In one embodiment, the cloud storage appliance 110 includes a virtual storage 130 that is accessible to the client 105 via the file system or block-level protocol commands (e.g., via NFS, CIFS or iSCSI commands). The virtual storage 130 is a storage system that may be, for example, a virtual file system or a virtual block device. The virtual storage 130 appears to the client 105 as an actual storage, and thus includes the names of data (e.g., file names or block names) that client 105 uses to identify the data. For example, if client 105 wants a file called newfile.doc, the client 105 requests newfile.doc from the virtual storage 130 using a CIFS, NFS or iSCSI read command. By presenting the virtual storage 130 to client 105 as though it were a physical storage, cloud storage appliance 110 may act as a storage proxy for client 105. In one embodiment, the virtual storage 130 is accessible to the client 105 via block-level commands (e.g., via iSCSI commands). In this embodiment, the virtual storage 130 is represented as a storage pool, which may include one or more volumes, each of which may include one or more logical units (LUNs).

In one embodiment, the cloud storage appliance 110 includes a translation map 135 that maps the names of the data (e.g., file names or block names) that are used by the client 105 into the names of data chunks that are stored in the storage clouds 115. The data chunks may each be identified by a permanent globally unique identifier. Therefore, the cloud storage appliance 110 can use the translation map 135 to retrieve data chunks from the storage clouds 115 in response to a request from client 105 for data included in a LUN, volume or pool of the virtual storage 130. Data chunks may be compressed data chunks. Data chunks are discussed in greater detail below.

The cloud storage appliance 110 may also include a local cache (not shown) that contains a subset of data stored in the storage cloud 115. The cache may include, for example, data that has recently been accessed by one or more clients 105 that are serviced by cloud storage appliance 110. The cache may also contain data that has not yet been written to the storage cloud 115. The cache may be a cache hierarchy that includes a memory cache and a disk cache. Upon receiving a request to access data, cloud storage appliance 110 can check the contents of the cache before requesting data from the storage cloud 115. That data that is already stored in the cache does not need to be obtained from the storage cloud 115.

In one embodiment, when a client 105 attempts to read data, the client 105 sends the cloud storage appliance 110 a name of the data (e.g., as represented in the virtual storage 130). The cloud storage appliance 110 determines the most current version of the data and a location or locations for the most current version in the storage cloud 115 (e.g., using the translation map 135). The cloud storage appliance 110 then obtains the data. In one embodiment, the data fetching module 125 obtains the requested data from the storage cloud 115.

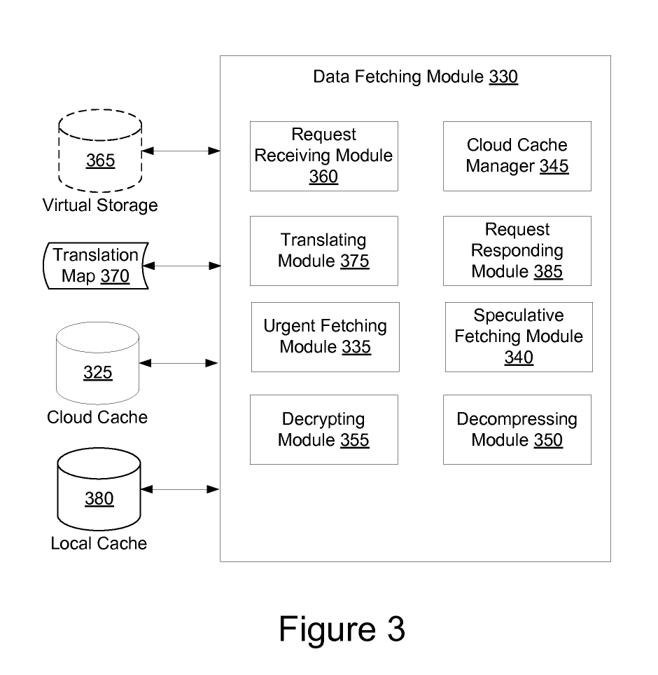

Once the data fetching module 125 obtains the data, it may then decompress and decrypt the data, and then provide the data to the client 105. Additionally, the data may have been subdivided into multiple data chunks that were compressed and written to the storage cloud 115. The data fetching module 330 may combine the multiple data chunks to reconstruct the requested data. To the client 105, the data is accessed using a file system or block-level protocol (e.g., CIFS, NFS or iSCSI) as though it were uncompressed clear text data on local network storage. It should be noted, though, that the data may still be separately encrypted over the wire by the file system or block-level protocol that the client 105 used to access the data. The data fetching module 125 is described in greater detail below with reference to FIG. 3.

When a client 105 attempts to store data, the data is first sent to the cloud storage appliance 110. The compression pipeline module 128 separates the data into data chunks, finds reference chunks (also referred to herein as target data chunks) to compress the data chunks against, compresses the data chunks (including performing deduplication and conventional compression), groups together compressed data chunks into cloud files, and sends the cloud files to the storage cloud 115 using protocols understood by the storage cloud 115. In one embodiment, the compression pipeline module 128 performs these operations upon receiving a command to generate a snapshot of the virtual storage 130.

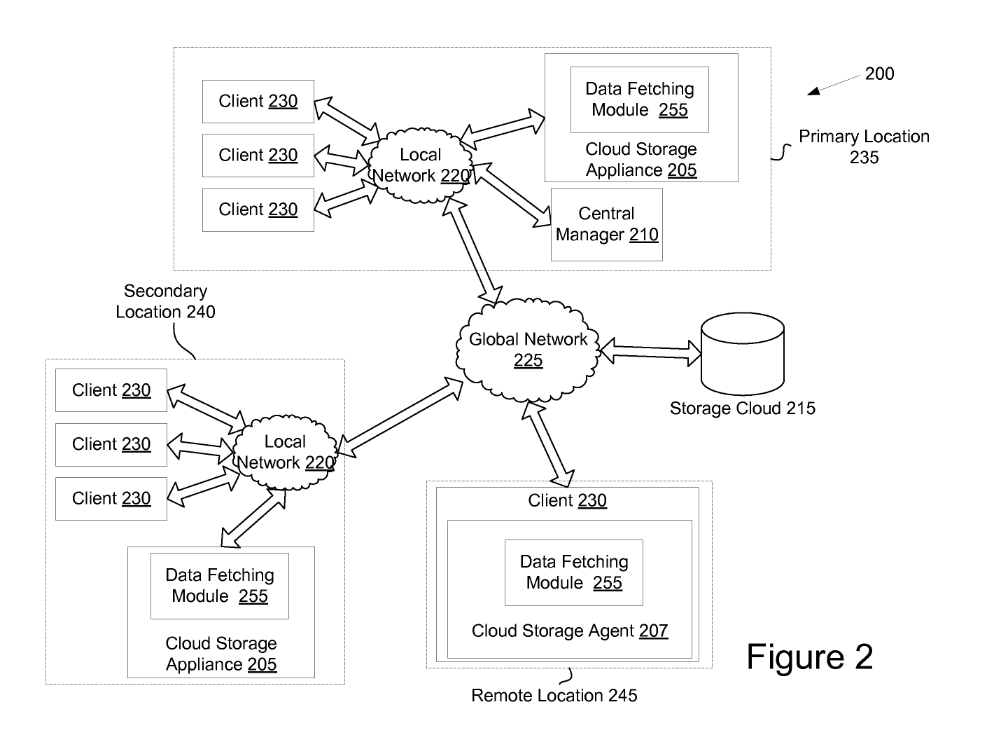

An enterprise may use multiple cloud storage appliances, and may include one or more cloud storage agents, all of which may be managed by a central manager to maintain data coherency. FIG. 2 illustrates an exemplary network architecture 200, in which multiple cloud storage appliances 205 and a cloud storage agent 207 are used at different locations (e.g., primary location 235, secondary location 240, remote location 245, etc.). Network architecture 200 further shows a storage cloud 215 connected with the cloud storage appliances 205 and cloud storage agent 207 via a global network 225. The global network 225 may be a public network, such as the Internet, a private network, such as a wide area network (WAN), or a combination thereof.

Each location in the network architecture 200 may be a distinct location of an enterprise. For example, the primary location 235 may be the headquarters of the enterprise, the secondary location 240 may be a branch office of the enterprise, and the remote location 245 may be the location of a traveling salesperson for the enterprise. Some locations include one or more clients 230 connected to a cloud storage appliance 205 via a local network 220. Other locations (e.g., remote location 245) may include only one or a few clients 230, one of which hosts a cloud storage agent 207. Additionally, in one embodiment, one location (e.g., the primary location 235) includes a central manager 210 connected to that location's local network 220. In another embodiment, the central manager 210 is provided as a service (e.g., by a distributor or manufacturer of the cloud storage appliances 205), and does not reside on a local network of an enterprise. Alternatively, one of the storage appliances may act as the central manager.

The cloud storage appliances 205, cloud storage agent 207 and central manager 210 operate in concert to provide the storage cloud 215 to the clients 230 to enable those clients 230 to store data to the storage cloud 215 using standard file system or block-level protocol semantics (e.g., CIFS, NFS, or iSCSI). Together, the cloud storage agent 207, cloud storage appliances 205 and central manager 210 emulate the existing file system stack or block-oriented storage that is understood by the clients 230. Therefore, the cloud storage appliances 205, cloud storage agent 207 and central manager 210 can together provide a functional equivalent to traditional file system or block-level storage servers, and thus eliminate any need for traditional file system or block-level storage servers. In one embodiment, the cloud storage appliance 205 and central manager 210 together provide a cloud storage optimized file system that sits between an existing stack of a conventional file system or block-level protocol (e.g., NFS, CIFS or iSCSI) and physical storage that includes the storage cloud and caches of the user agents.

Central manager 210 is responsible for ensuring coherency between different cloud storage appliances 205 and cloud storage agents 207. To achieve such coherency, the central manager 210 may manage data object names, manage the mapping between virtual storage and physical storage, manage file locks, manage encryption keys, and so on. The central manager 210 in one embodiment ensures synchronized access by multiple different cloud storage appliances and cloud storage agents to data stored within the storage cloud 215. Central manager 210 may also maintain data structures of the most current versions of all data chunks stored in the storage cloud 215. The cloud storage agent 207 and cloud storage appliances 205 may check with the central manager 210 to determine the most current version of data and a location or locations for the most current version in the storage cloud 215. The cloud storage agent 207 or cloud storage appliance 205 may then use the information returned by the central manager 210 to obtain the data from the storage cloud 215.

Each of the cloud storage appliances 205 and cloud storage agent 207 may include a data fetching module 207. The data fetching module 255 satisfies read requests from clients 230 when the read requests are requests for data that is not cached by the cloud storage appliance 205 or cloud storage agent 207. The data fetching module 255 is described in greater detail below with reference to FIG. 3.

FIG. 3 illustrates a block diagram of a data fetching module 330, in accordance with one embodiment of the present invention. The data fetching module 330 in various embodiments corresponds to data fetching modules 125 and 255 of FIGS. 1 and 2, respectively. In one embodiment, the data fetching module 330 includes an urgent fetching module 335, a speculative fetching module 340, a decrypting module 355, a decompressing module 350, a receiving module 360, a translating module 375, a request responding module 385, and a cache manager 345.

Receiving module 360 receives read requests from clients. The read requests may be requests for files or blocks in a virtual storage 365 that is viewable to the clients. In one embodiment, the translating module 375 uses a translation map 370 to translate the read requests into logical addresses (e.g., logical block addresses) of one or more data chunks. Each of the data chunks is a unit of data that is used for physical storage of the data in a storage cloud. In one embodiment, the data chunks have an uncompressed size of approximately 64 kb. Alternatively, the data chunks may be 1 MB, 10 MB, 32 kb, or other larger or smaller sizes. The size of the data chunks may be independent from the block size of data blocks used by the file systems or block-level systems that interface with clients (e.g., as represented in the virtual storage 365). For example, a file system block size may be 4 kb, while the chunk size may be 64 kb or larger.

In one embodiment, each of the data chunks stored in the storage cloud is grouped along with other data chunks into a cloud file. Each cloud file may have up to a threshold size, and may include up to a threshold number of data chunks. Thus, in one embodiment, the cloud file size is limited by the number of data chunks it includes as well as the total size of the cloud file. Alternatively, the cloud file size may be limited only by its total size or by only the number of data chunks it contains. The size threshold for the cloud files may be chosen based on how frequently its contents are updated, cost per operation charged by cloud storage provider, etc. In one embodiment, the cloud file size threshold is 1 MB. However, other smaller or larger size thresholds may also be used, such as 500 KB, 5 MB, 15 MB, etc.

The cloud files have a cloud file format. In one embodiment, each cloud file includes a directory that identifies where in the cloud file each compressed data chunk is located, the sizes of the data chunks, and/or the number of compressed data chunks in the cloud file. The cloud file may also include a header that identifies where in the cloud file the directory is located. The header may also indicate a size of the cloud file and a size of the directory. The cloud file may also include a cloud descriptor. The cloud descriptor indicates which data chunks are referenced by data chunks stored in the cloud file. Each cloud file may have a unique identifier (e.g., a file number such as 000021). In one embodiment, the unique identifier includes a hash to randomize alphabetical ordering of information.

In one embodiment, once the logical address of the data chunk is determined, the data fetching module 330 checks a local cache 380 to determine whether the requested data chunk is contained in the local cache 380 using the logical address. If the data chunk is contained in the local cache 380, the request responding module 385 returns the uncompressed data chunk to the requestor.

If the data chunk is not in the local cache 380, urgent fetching module 335 sends a read request to the storage cloud for the data chunk. The urgent fetching module 335 may use the logical address to determine the cloud file that the data chunk is contained in, as well as the location in the cloud file where the data chunk is located. In one embodiment, the urgent fetching module 335 requests the entire cloud file that contains the requested data chunk. Alternatively, the urgent fetching module 335 may fetch just the requested data chunk using a partial file read request. For example, the urgent fetching module 335 may fetch the requested data chunk from the storage cloud using an HTTP partial GET command by specifying the name of the cloud file, a location in the cloud file where the data chunk begins, and a size of the data chunk. The translating module 375 determined the cloud file that contains the data chunk, as well as the location in the cloud file where the data chunk is contained and the size of the data chunk. Therefore, the urgent fetching module 335 is able to specify in the partial read request a name of the requested cloud file as well as a byte range within that cloud file that includes the specified data chunk. Once the data chunk is retrieved, urgent fetching module 335 places the data chunk into cloud cache 325. In one embodiment, the data chunk is placed in the cloud cache 335 in a compressed form.

Data chunks stored in the storage cloud are typically encrypted. In one embodiment, upon urgent fetching module 335 retrieving a data chunk from the storage cloud, decrypting module 355 decrypts the data chunk using an encryption key that was used to encrypt the data chunk. Urgent fetching module 335 may then place the decrypted data chunk in the cloud cache 325 after it has been decrypted.

Data chunks stored in the storage cloud have typically been compressed. The data chunks may have been compressed using multiple compression techniques. The compression schemes used to compress the data chunks are all lossless compression schemes. Therefore, compressed data chunks may be decompressed to reproduce original data chunks exactly.

In one embodiment, data chunks are compressed using a conventional compression algorithm such as gun zip (gzip), Basic Leucine Zipper 2 (bzip2), Lempel-Ziv-Markov chain algorithm (LZMA), or other compression algorithms. The compressed data chunks may include a header that identifies the compression algorithm that was used to compress the data chunks. This identifies to the decompressing module 350 the compression algorithms to use for decompressing each data chunk.

In one embodiment, at least some data chunks stored in the storage cloud have been compressed using a reference compression scheme (known as deduplication). In such a compression scheme, compression is achieved by replacing portions of a data chunk with references to previous occurrences of the same data in one or more previously stored data chunks (referred to as reference chunks). The compressed data chunk may include both raw data (for the unmatched portions) and references (for the matched portions). In an example, if a compressor found matches for two portions of a data chunk, it would provide references for those two portions. The rest of the compressed data chunk would simply be the raw data. Therefore, a compressed data chunk might have 7 bytes of raw data, followed by a pointer to reference chunk 99 offset 5 for 66 bytes, followed by 127 bytes of clear data, followed by a pointer to reference chunk 1537 offset 47 for 900 bytes, etc. In one embodiment, each match is encoded in a MATCH token, which contains the size of the match and the starting offsets in both the data chunk and reference chunks. In one embodiment, any data that does not match is encoded in a MISS token, which contains an offset and size followed by clear text data.

In one embodiment, urgent fetching module 335 fetches referenced data chunks as well as requested data chunks. For example, in one embodiment, when a data chunk is requested, the urgent fetching module 335 locks that data chunk. When the urgent fetching module attempts to lock the requested data chunk, this generates requests for any referenced data chunks. Those requests cause the referenced data chunks to be locked, which in turn causes additional requests for any further referenced data chunks to be generated. This process occurs recursively, until there are no additional referenced data chunks. This process causes the last referenced data chunks to be added to a queue for retrieval before the referencing data chunks are added to the queue. Therefore, the requested data chunk may be added to the queue last (and thus fetched last). As the data chunks are retrieved, they are added to the cloud cache 325.

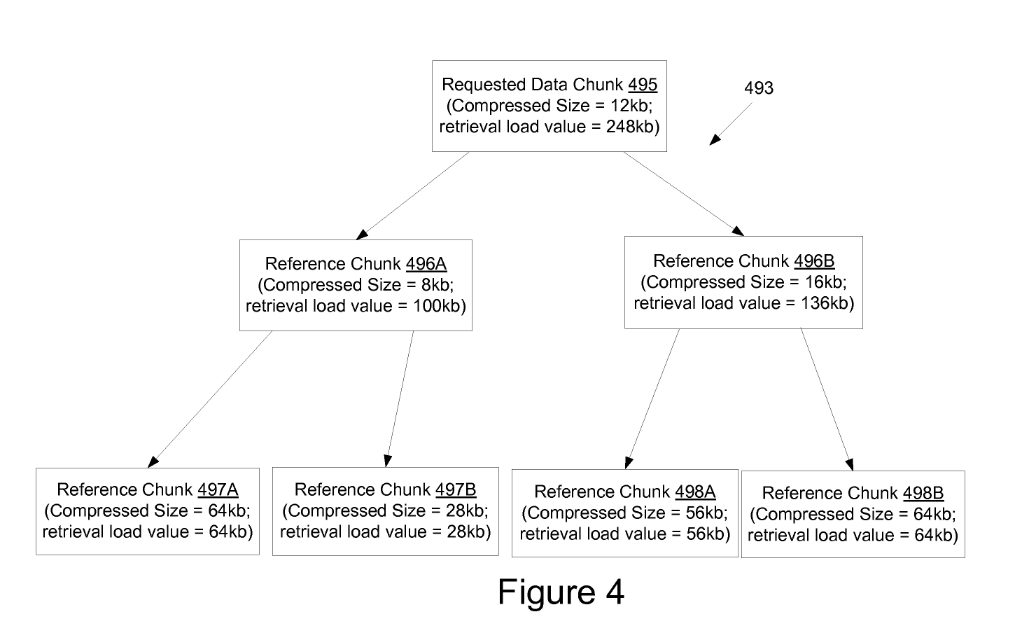

FIG. 4 diagrammatically shows a reference tree 493 for a compressed data chunk 495. In one embodiment, each data chunk references at most two reference chunks. Additionally, each of the reference chunks may themselves reference at most two other reference chunks, and so on. Therefore, the width of references (number of reference chunks a single data chunk can compress against) is limited to a maximum of 2 in one embodiment. Note that in other embodiments the width of references and/or the depth of references may be increased beyond 2. For example, the width of references may be set to 2 and the depth of references may be 4 or more.

In one embodiment, the depth of references is limited by the retrieval load value of the data chunk 495. Each reference chunk and data chunk may include its own retrieval load value. The retrieval load value for a reference chunk is equal to the size of the reference chunk plus the sizes of any additional reference chunks that it references. For example, reference chunks 497A and 498B each have a retrieval load value of 64 kb, reference chunk 497B has a retrieval load value of 28 kb and reference chunk 498A has a retrieval load value of 56 kb. Since none of reference chunks 497A, 497B, 498A or 498B reference any other reference chunks, their retrieval load values reflect the actual compressed size of these reference chunks. Reference chunk 496A references reference chunk 497A and reference chunk 497B. Therefore, reference chunk 496A has a retrieval load value of 100 kb, which includes the size of reference chunk 496A (8 kb) plus the retrieval load values of reference chunk 497A (64 kb) and reference chunk 497B (28 kb). Similarly, data chunk 495 has a retrieval load value of 248 kb, which includes the size of data chunk (12 kb) plus the retrieval load values of reference chunk 496A (100 kb) and reference chunk 496B (136 kb).

A retrieval load threshold may be set by the cloud storage appliance. The retrieval load threshold in one embodiment is set based on available network resources. The available network resources control the quantity of data that can be sent over the network in a given time period. For example, a T1 line has a line rate speed of 1.544 Mbits/s and a T3 line has a line rate speed of 44.376 Mbits/s. In one embodiment, the retrieval load threshold is set such that a threshold number of data chunks (e.g., 128 data chunks) can be retrieved from the storage cloud within 2 minutes, 5 minutes, or some other predefined time period. For example, a retrieval load threshold of 8 MB may be set for a T1 line. The retrieval load may be proportional or equal to a retrieval load budget, which is also determined based on the available network resources.

Once the retrieval load value for a data chunk reaches a retrieval load threshold, the data chunk cannot be referenced by any other data chunks. For example, if the retrieval load threshold was 248 kb, then data chunk 495 would not be referenced by any other data chunks.

Requested data chunk 495 was compressed by replacing portions of data chunk 495 with references to reference chunk 496A and 496B. Additionally, reference chunk 496A was compressed by replacing portions of reference chunk 496A with references to reference chunk 497A and reference chunk 497B. Additionally, reference chunk 496B was compressed by replacing portions of reference chunk 496B with references to reference chunk 498A and reference chunk 498B. Therefore, in one embodiment, to obtain data chunk 495, urgent fetching module 335 would first retrieve reference chunks 497A, 497B, 498A and 498B. Urgent fetching module 335 would then fetch reference chunks 496A and 496B. Data chunk 495 would then be retrieved last.

Returning to FIG. 3, decompressing module 350 decompresses requested data chunks. To decompress a data chunk that has been compressed using deduplication, each of the referenced data chunks must be obtained. In one embodiment, once urgent fetching module 335 has fetched a requested data chunk, it has already fetched all additional data chunks referenced by the requested data chunk. Thus, it can be guaranteed that urgent fetching module 335 has also fetched all reference chunks that will be necessary to decompress the requested data chunk. For example, in FIG. 4 reference chunks 496A, 496B, 497A, 497B, 498A and 498B would be retrieved before data chunk 495 is retrieved. Thus, once urgent fetching module 335 retrieves a requested data chunk, decompressing module 350 can begin decompressing the data chunk.

In one embodiment, decompressing module 350 decompresses the requested data chunk and each of the reference chunks that will be needed to decompress it using a conventional compression algorithm (e.g., GZIP, etc.). Decompressing module 350 then replaces each of the MATCH tokens with the referenced data identified in the MATCH tokens. This is performed recursively, so that MATCH tokens in reference chunks are also replaced with actual data. Thus, decompressing module 350 fully reconstructs the original data. Once the data chunk is decompressed, request responding module 355 returns the decompressed data chunk to the requesting client. The requested data chunk and additional reference chunks may then be removed from the cloud cache 325 after the data chunks have been consumed (after the requested data chunk is returned to a requestor).

Typically, receiving module 360 will receive numerous read requests at a time, and urgent fetching module 335 will generate multiple fetches to the storage cloud at a time. For example, urgent fetching module 335 may generate tens or hundreds of partial reads per second. Each of the requests for data chunks will use up some amount of available network bandwidth. The total amount of network bandwidth that will be used in a specified time period is dependent on not only the size of the requested data chunk, but also the sizes of any data chunks that it references, as well as the data chunks that those data chunks reference, and so on. The specified time period may be, for example, 0.5 s, 1 s, 2 s, 5 s, etc. The compressed sizes of reference chunks may be maintained in a descriptor table. Data fetching module 330 may compute the total amount of bytes of data that will be fetched from the storage cloud using the descriptor table. In addition to data chunk sizes, the descriptor table may also include information identifying which cloud files data chunks are in, locations in the cloud files, etc.

In one embodiment, the data fetching module 330 computes a sum of the data chunk sizes for all data chunks that will be retrieved (including the requested data chunks and all additional reference data chunks). The data fetching module 330 may then subtract the combined size of the requested data chunks and additional data chunks from the total amount of bytes of data that can be retrieved in the specified time frame. Thus, the data fetching module 330 computes an amount of remaining bandwidth for the time period.

As discussed above, the total amount of bytes that can be retrieved from the storage cloud in a given time period is based on available network resources for that time period. For example, a T1 line has a line rate speed of 1.544 Mbits/s and a T3 line has a line rate speed of 44.376 Mbits/s. Therefore, in a T1 line, for example, 7.72 Mbits can be retrieved from the storage cloud in 5 seconds. In some situations, available network bandwidth may be variable based on network conditions or other external factors. For example, network congestion, bandwidth throttling by an internet service provider (ISP), network load, etc. may affect an available network bandwidth. Additionally, the transfer control protocol (TCP) includes a slow start algorithm that is used by many internet applications. The TCP slow start algorithm uses a variable sized congestion window that controls the number of bytes that can be outstanding at a given time. The congestion window initially has a small size, which limits the number of bytes that can be sent over the wire (between the storage cloud and the cloud storage appliance). The congestion window size is then grown until a maximum size is eventually reached. Accordingly, current size of the congestion window may affect the available network bandwidth in addition to network conditions.

In one embodiment, the amount of available network resources (and thus the available bandwidth for a time period) is predicted based on current network conditions and previous network conditions. The previous network conditions may include previous network conditions over the past 5 seconds, 2 minutes, 5 minutes, hour, day, etc. In one embodiment, the cloud storage appliance computes one or more statistical values from the previous network conditions and/or the current network conditions. For example, average network conditions, network condition trends, etc. may be computed. The trends may include network condition trends over a past few minutes. In one embodiment, recent trends are projected into the future to predict future network conditions. The trends may also identify particular days, times of day, etc. that are correlated with improved or degraded network conditions.

In one embodiment, the bandwidth that will be available in the predetermined time period is predicted according to the following technique. A maximum number of bytes on the wire that the network can be committed to for a predetermined time period (e.g., 5 seconds) at a last known bandwidth is tracked. Additionally, a number of bytes on the wire that are currently committed, and that still need to be retrieved from the storage cloud is tracked. A maximum number of bytes on the wire that was calculated in a previous time slice (or maximum from multiple previous time slices) is also tracked. In one embodiment, a periodic callback is sent out to the storage cloud in each time period (e.g., every 5 seconds). A response to the callback may be used to track the maximum number of bytes for a time period. The system can calculate any trends in the bandwidth (e.g., bandwidth increasing, bandwidth decreasing, or bandwidth remaining stable) using the current value of the maximum number of bytes on the wire and the maximum number of bytes on the wire from the previous time slice (or time slices).

The network connection between the cloud storage appliance and the storage cloud may be a wired connection, a wireless connection, or a combination thereof. An example of external factors that affect network bandwidth for wireless connections are distance from a transmitter (e.g., a cell tower of a wireless service provider) and signal to noise ratio. In one embodiment, an amount of available network resources for a specified time period (e.g., the next 5 seconds, 2 minutes, 5 minutes, etc.) is predicted. This predicted value may be used to set the retrieval load threshold. In one embodiment, the amount of available network resources is predicted based on past and present network conditions and past and present external factors (e.g., such as signal to noise ratio).

Often, the combined sizes of the requested data chunks and any additional reference data chunks will not use up all network bandwidth in the specified time period. Accordingly, speculative fetching module 340 may use the remaining bandwidth in the time period to fetch additional unrequested data. In one embodiment, speculative fetching module determines unrequested data that is likely to be requested in the future (e.g., in the next 2 minutes, in the next 15 minutes, in the next hour, etc.), and requests such data speculatively. Unrequested data is likely to be requested in the future if it has a higher probability than average of being requested. It may be determined that unrequested data has a higher probability than overage of being requested if it is associated with requested data (e.g., a cloud file has a higher than average probability of being requested if it contains multiple data chunks that have been requested already). In one embodiment, the speculative fetching module 340 retrieves one or more entire cloud files speculatively (without first receiving requests for all of the data chunks in the cloud files). For example, speculative fetching module 340 may determine cloud files that contain data chunks that are likely to be requested in the near future, and retrieve one or more of these cloud files.

The requested data chunks may be payload data chunks or metadata data chunks. In one embodiment, a single cloud file contains either payload data chunks or metadata data chunks from a particular metadata layer, but not both. In one embodiment, if the requested data chunk is a metadata data chunk, then the entire cloud file that contains that metadata data chunk is retrieved.

Note that the speculative fetching module 340 is described herein as fetching entire cloud files speculatively for clarity and brevity. However, it should be understood that speculative fetching module 340 may also fetch less than an entire cloud file speculatively. For example, speculative fetching module 340 may fetch half of the data chunks in a cloud file speculatively. In another example, if there is only enough remaining bandwidth for one and a half whole cloud files, then speculative fetching module 340 may request one entire cloud file and half of another cloud file speculatively. When less than an entire cloud file is fetched, this may be performed using a partial file read (e.g., an HTML partial GET request) using the starting byte offset of the first data chunk to fetch from the cloud file and a length that is equal to the sizes of all data chunks that will be retrieved from the cloud file. In one embodiment, if less than an entire cloud file is to be fetched speculatively, then all of the data chunks in that cloud file that are to be fetched must be adjacent to one another. Additionally, in one embodiment a header and directory of the cloud file are also retrieved if less than an entire cloud file is fetched. In one embodiment, to speculatively fetch less than an entire cloud file, a partial read is performed specifying the cloud file and the amount of data in the cloud file to retrieve. The speculative fetching module 340 may then request all data from the beginning of the cloud file (including the header, directory and other metadata) to the end of one of the data chunks in the cloud file.

As discussed above, speculative fetching module 340 attempts to fetch data that is likely to be requested in the future. In one embodiment, the speculative fetching module 340 tracks the cloud files that contain each of the recently requested data chunks. Additionally, the speculative fetching module 340 may keep a count of the number of requested data chunks in each of the cloud files. The speculative fetching module 340 may then order the cloud files based on number of requested data chunks that they contain. In one embodiment, the speculative fetching module 340 checks the cloud file that contains the largest number of recently requested data chunks, and determines whether there is enough remaining bandwidth in the time period to retrieve that cloud file. In one embodiment, the descriptor table includes the sizes of cloud files as well as the sizes of data chunks. Alternatively, a separate table may record the sizes of the cloud files. If there is enough bandwidth remaining in the time period, speculative fetching module 340 may retrieve that cloud file. In one embodiment, if there is not enough remaining bandwidth, speculative fetching module 340 determines whether the cloud file with the next highest number of requested data chunks is smaller than or equal to the amount of bytes that can be retrieved with the remaining bandwidth for the time period. Alternatively, the cloud file with the highest number of requested data chunks may be retrieved even if there is not enough bandwidth in the current time period to fully retrieve it. In such an instance, part of the cloud file is retrieved in the current time period, and the remainder of the cloud file is retrieved in a subsequent time period. The speculative fetching module 340 may repeat the procedure of determining cloud files to prefetch until the remaining amount of bandwidth in the time period is full. However, in one embodiment only a single cloud file is partially retrieved in a time period. The speculative fetching module 340 then fetches the cloud files (and/or a portion of one cloud file) in the time limit while the urgent fetching module 335 fetches the requested data chunks.

In one embodiment, a cloud file is speculatively fetched when one or multiple speculative fetching criteria are met. The speculative fetching criteria include a threshold number of requested data chunks criterion for a cloud file. The threshold number of requested data chunks criterion may be satisfied when at least a threshold number of data chunks contained in a single cloud file have been requested. The speculative fetching criteria may also include a network conditions trend criterion that is satisfied if the trend for the available network resources shows that the available network resources are remaining steady or are increasing. The speculative fetching criteria may also include a remaining bandwidth criterion. In one embodiment, the remaining bandwidth criterion is satisfied if there is any available remaining bandwidth in the time period. In other embodiments, the remaining bandwidth criterion is satisfied if a threshold amount of bandwidth is remaining for the time period (a threshold number of bytes). This threshold may be less than the size of a cloud file, may be equal to the size of a cloud file, or may be larger than the size of a cloud file. In one embodiment, a cloud file is retrieved when all of the speculative fetching criteria are satisfied. Alternatively, a cloud file may be retrieved when only some of the criteria are satisfied. Accordingly, the data fetcher may recognize and adapt to changes in available bandwidth in less than a second.

In addition to the above described technique for identifying cloud files that include data chunks that are likely to be requested, other techniques may also be used to make such a determination. In one embodiment, cloud files are identified for prefetching based on cloud file addresses. For example, if cloud files 1-4 have been recently requested and/or multiple data chunks contained in each of cloud files 1-4 have been recently requested, cloud file 5 may be prefetched. In another embodiment, the speculative fetching module 335 maintains a history of cloud files that have been fetched, and data chunks that have been used from the prefetched cloud files. The speculative fetching module 335 may analyze the information on fetched cloud files and used data chunks from those cloud files to make improved decisions on which cloud files to prefetch. The speculative fetching module 335 may, for example, identify patterns in the maintained history that are indicative of cloud files that contain data chunks that will be used. For example, cloud files having properties A and B but lacking property C may be identified as cloud files that likely have data chunks that will be used. In one embodiment, the cloud storage appliance maintains data on the file system that is used by clients. The cloud storage may maintain a data structure that maps files in the client's file system to data chunks and/or cloud files. The speculative fetching module 335 may analyze the file system data to identify patterns that are not apparent with just the data chunk and cloud file history data.

In one embodiment, the cloud cache 325 contains data chunks. The data chunks may be cached in their compressed form. In one embodiment, the data chunks are stored in increasing numerical order based on their logical address.

When a cloud file is retrieved, speculative fetching module 340 may divide the cloud file into individual data chunks. In one embodiment, each of the cloud files has a directory that identifies the location and size of each of the data chunks that it contains. The speculative fetching module 340 may use this directory to separate the cloud file into the individual data chunks that it contains. The speculative fetching module 340 then places each of the individual data chunks in the cloud cache 325.

When receiving module 360 receives a future read request, data fetching module 330 may check the cloud cache 325 to see if the requested data chunks have been fetched from the storage cloud speculatively. If the data chunks have been fetched speculatively (e.g., if the cloud files containing the requested data chunks have been retrieved), then there is no need to fetch the data chunks from the storage cloud in response to the read request. However, it may still be necessary to retrieve the data chunks referenced by the requested data chunk if any of those data chunks were not also fetched speculatively.

Cache manager 345 manages eviction policies for the cloud cache 325. In one embodiment, cache manager 345 includes two eviction policies (policies for removing data chunks from the cloud cache 325). Using a first eviction policy, cache manager 345 evicts data chunks that have been consumed (those data chunks that have been returned to a requestor). Once a data chunk is returned to a requestor, it is stored in local cache, therefore there is no need to keep these data chunks in the cloud cache 325. Using the second eviction policy, the cache manager 345 begins evicting data chunks in the cloud cache 325 when the cloud cache reaches a threshold capacity. When the cloud cache 325 reaches the threshold capacity (e.g., on 15% of the cache is free), the cache manager 345 begins evicting data chunks using a least recently used eviction policy. The cache manager 345 evicts data chunks until the cloud cache 325 reaches a second threshold capacity (e.g., 40% of cache is free). Note that since data chunks are evicted using the first eviction policy as soon as they are consumed, all requested data chunks and additional data chunks that they reference may be evicted using the first eviction policy. Thus, the second eviction policy may be used to evict speculatively fetched data chunks. Other eviction policies may also be used. For example, a timestamp eviction policy may be used, in which data chunks with timestamps that indicate that the data chunks have been in the cloud cache 325 for more than a threshold amount of time are evicted.

The above described data fetching is performed after a storage pool and snapshot have been mounted. When a storage pool and/or snapshot is initially mounted, additional operations may be necessary to begin fetching data chunks. As used herein, a storage pool is a logical storage container that corresponds to a particular account with a cloud storage provider. The storage pool may be divided into logical volumes and logical units (LUNs). A snapshot is a copy of the state of the virtual storage (or a portion of the virtual storage) as it existed at a particular point in time. The snapshot may be a snapshot of the pool, a volume within a pool, or an individual logical unit (LUN) of a volume. The snapshot may include the contents of payload data as it existed at the particular point in time, as well as contents of metadata such as a mapping between physical storage and virtual storage.

A snapshot may include multiple different cloud tables that map logical addresses of data chunks to storage locations in the storage cloud (e.g., to a url that can be used to retrieve the data chunk from the storage cloud). Each cloud table may represent a layer. In one embodiment, snapshots include a payload layer and one or more metadata layers. The cloud table for the payload layer includes information on payload data, such as files, applications, folders, etc. The cloud tables for the metadata layers include data that describe the payload data and/or other metadata. A first metadata layer may include information identifying names of payload data chunks, cloud files payload data chunks are contained in, offsets into cloud files where payload data chunks are located, sizes/lengths of payload data chunks, and so on. A second metadata layer may include information describing metadata data chunks from the first metadata layer. A third metadata layer may include information describing metadata data chunks from the second metadata layer, and so on. The cloud tables may be arranged into a cloud tree. The cloud tree is a hierarchical arrangement of cloud tables that maps the logical address space of the entire storage pool to a physical address space of the storage cloud. A top level cloud table may include a single entry that is the root of the cloud tree, while a bottom level cloud table may include a separate entry for each data chunk.

The snapshot may also include multiple logical address tables that map names of data from a virtual storage viewable to clients to names (e.g., logical addresses) used by the cloud storage appliance. A first logical address table may represent the actual logical addresses for the data chunks. A second logical address table may represent descriptors of the data chunks. A third logical address may represent descriptors of entries in the second logical address table, and so on. In one embodiment, snapshots include copies of the cloud tables and the logical address tables.

To mount a new storage pool, the data fetching module 330 fetches a superblock from a specified location in the storage cloud. The superblock is a cloud file containing information that describes the state of the storage pool at a given point in time. The superblock contains all data that is necessary to begin accessing a particular storage pool. The superblock may contain one or more snapshot tables that include information on the number of snapshots in the pool and information necessary to access those snapshots. The superblock may also contain one or more pool level tables. Additionally, the superblock may contain a pointer to a highest level cloud table that contains the root of a cloud tree. The superblock may also include additional administrative tables. The superblock is encrypted using the same key that is used to encrypt data chunks. Additionally, the cloud storage appliance generates a random string of data and encrypts it using the key. The cloud storage appliance attaches both the encrypted version and the unencrypted version of the random string of data to the superblock. When a cloud storage appliance first accesses a storage pool (e.g., when a new cloud storage appliance is installed), an administrator enters the name of the cloud storage provider and a cloud storage account (which together identify the storage pool). The administrator further enters one or more keys to gain access to the storage pool. The cloud storage appliance is preconfigured to include information on where in the storage cloud superblocks are located. The cloud storage appliance can therefore retrieve the superblock from the storage cloud when a cloud storage provider and account are identified. Once the superblock is retrieved, the cloud storage appliance uses the key (or keys) provided by the administrator to encrypt the unencrypted version of the random string of data that is attached to the superblock. The cloud storage appliance then compares the recently encrypted random string of data to the encrypted version of the random string of data attached to the superblock. If the encrypted strings of data match, then the key provided by the administrator is correct. The cloud storage appliance then decrypts the superblock using the key and deconstructs the superblock into individual cloud tables, logical block address tables, snapshot tables, and other tables. The cloud storage appliance can then begin accessing the storage pool. Additionally, the cloud storage appliance can construct a virtual storage that includes viewable representations of all data in the storage pool for presentation to clients.

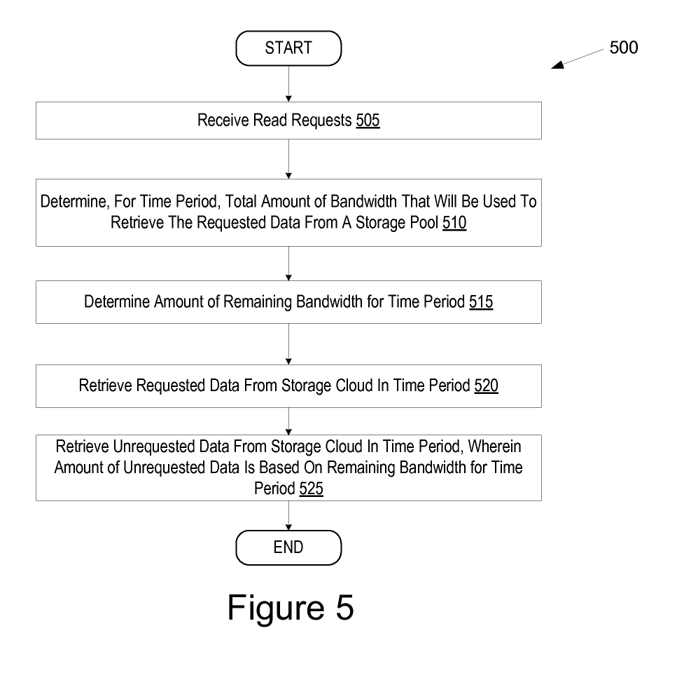

FIG. 5 is a flow diagram illustrating one embodiment of a method 500 for retrieving data from a storage cloud. Method 500 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 500 is performed by a cloud storage appliance (e.g., cloud storage appliance 110 of FIG. 1). Alternatively, method 500 may be performed by a cloud storage agent. Method 500 may be performed, for example, by a data fetching module running on a cloud storage appliance or cloud storage agent. For convenience, method 500 will be discussed with reference to a cloud storage appliance. However, it should be understood that method 500 may also be performed by other software and/or hardware elements.

Referring to FIG. 5, at block 505 of method 500 a cloud storage appliance receives multiple (e.g., tens, hundreds, etc.) read requests. Each read request may be a request for data that is stored in a storage cloud. At block 510, the cloud storage appliance determines a total amount of bandwidth that will be used to retrieve the requested data from a storage cloud to satisfy the multiple read requests. In one embodiment, the cloud storage appliance determines the amount of bandwidth that will be used for a predefined time period (e.g., 2 seconds). Accordingly, determining the amount of bandwidth that will be used includes determining the size of the data that will be retrieved. This may include the size of the requested data itself, and the sizes of any additional data that is referenced by the requested data. The sizes of requested data and/or additional data may be determined from descriptor tables (e.g., bottom level cloud tables) maintained by the cloud storage appliance.

At block 515, the cloud storage appliance determines an amount of remaining bandwidth for the time period. For example, if the cloud storage appliance has an available network bandwidth of 1.544 Mbits/s, or about 192,000 bytes/s (the bandwidth of a T1 line), and the predetermined time period is 2 seconds, then the a total of 384,000 bytes can be fetched in the time period. If the read requests will cause 200,000 bytes of data to be fetched from the storage cloud, then 184,000 bytes are remaining in the time period.

At block 520, the cloud storage appliance retrieves the requested data from the storage cloud. At block 525, the cloud storage appliance retrieves unrequested data from the storage cloud. The amount of unrequested data that is retrieved from the storage cloud may be less than or equal to the remaining bandwidth in the time period (e.g., 184,000 bytes in the above example). Using method 500, a cloud storage appliance may commit network resources to the retrieval of data (e.g., data chunks and/or cloud files) within the time period. In one embodiment, no resources are committed outside of the time period. Alternatively, some resources may be committed outside the time period for retrieving unrequested data. If an additional read request is received during the time period, the additional read request may be assigned to a subsequent time period after the entire bandwidth for the time period is committed. In one embodiment, it may be guaranteed that read requests will be fulfilled within a predetermined amount of time from when the requests are generated.

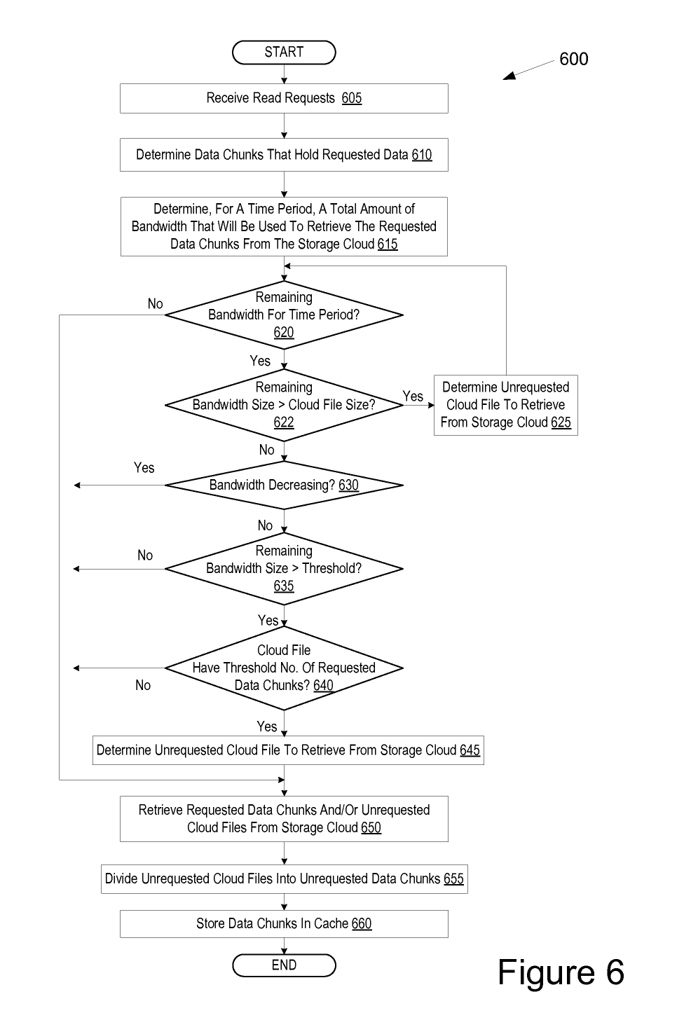

FIG. 6 is a flow diagram illustrating another embodiment of a method 600 for retrieving data from a storage cloud. Method 600 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 600 is performed by a cloud storage appliance (e.g., cloud storage appliance 110 of FIG. 1). Alternatively, method 600 may be performed by a cloud storage agent. Method 600 may be performed, for example, by a data fetching module running on a cloud storage appliance or cloud storage agent. For convenience, method 600 will be discussed with reference to a cloud storage appliance. However, it should be understood that method 600 may also be performed by other software and/or hardware elements.

Referring to FIG. 6, at block 605 of method 600 a cloud storage appliance receives multiple read requests, each of which may have a timestamp. The read requests may be requests for data in a virtual storage that is viewable to clients. However, that data may actually be physically stored in remote locations (e.g., in a storage cloud), with a different structure than is presented to the clients. In one embodiment, the requested data is included in one or more data chunks, each of which is in turn included in a cloud file that holds multiple data chunks. At block 610, the cloud storage appliance determines what data chunks hold the requested data. In one embodiment, the cloud storage appliance walks through a first series of tables that map the client viewable data to logical addresses. The cloud storage appliance then walks though a second set of tables to identify locations in the storage cloud where the data chunks are stored.

At block 615, the cloud storage appliance determines a total amount of bandwidth that will be used to retrieve the requested data chunks from a storage cloud to satisfy the multiple read requests. In one embodiment, the cloud storage appliance determines the amount of bandwidth that will be used for a predefined time period (e.g., 2 seconds). Accordingly, determining the amount of bandwidth that will be used includes determining the size of the data chunks that will be retrieved. This may include the size of the requested data chunks themselves, and the sizes of any additional data chunks that are referenced by the requested data chunks. This information may be included in one of the previously mentioned series of tables.

At block 620, the cloud storage appliance determines whether there is any remaining bandwidth for the time period. If there is remaining bandwidth in the time period, then the cloud storage appliance also computes the amount of remaining bandwidth. If there is no remaining bandwidth in the time period, the method proceeds to block 650. If there is remaining bandwidth in the time period, the method continues to block 622.

At block 622, the cloud storage appliance determines whether the amount of remaining bandwidth has a size that is greater than or equal to the size of a cloud file. If so, then the method continues to block 625. Otherwise, the method continues to block 630.

At block 625, the cloud storage appliance determines an unrequested cloud file to retrieve from the storage cloud. In one embodiment, the cloud storage appliance keeps track of the identities of cloud files that include a requested data chunk (e.g., in a list, table or other data structure). The cloud storage appliance may track the number of requested data chunks held by each of these cloud files. When there is remaining bandwidth in the time period, the cloud storage appliance may review the list (or other data structure) of cloud files, and select one of those cloud files for retrieval. The selected cloud file has a size that may use up but not exceed the amount of remaining bandwidth in the time period. For example, if there was 400 MB remaining in the time period, then the selected cloud file could have a size of up to 400 MB. In one embodiment, the cloud storage appliance selects a cloud file that includes the most requested data chunks for retrieval. In another embodiment, the cloud storage appliance selects a cloud file that satisfies a threshold number of requested data chunks criterion. In other embodiments, other heuristics are used to identify patterns in the requested data chunks and predict which cloud files include the most data chunks that will be requested in the future. The method then returns to block 620 to determine if there is still remaining bandwidth for the time period.

At block 630, the cloud storage appliance determines whether an amount of bandwidth in the time period is increasing, decreasing, or remaining steady. In one embodiment, the network bandwidth is tested for every time period. The bandwidth for a current time period may be compared with bandwidths in one or more previous time periods to determine bandwidth trends. If the current bandwidth is greater than or equal to a bandwidth in a previous time period, then it may be determined that the bandwidth is increasing or remaining steady. If the current bandwidth is less than a bandwidth in the previous time period, then it may be determined that the bandwidth is decreasing. If the bandwidth is decreasing, the method proceeds to block 650. If the bandwidth is increasing or remaining steady, the method continues to block 635.

At block 635, the cloud storage appliance determines whether the amount of remaining bandwidth is greater than a bandwidth threshold. In one embodiment, the bandwidth threshold is one byte. Thus, if there is at least one byte remaining, the bandwidth threshold is satisfied. Alternatively, the bandwidth threshold may be less than a byte (e.g., 1 bit) or more than a byte (e.g., 512 bytes). If the bandwidth threshold is satisfied, the method continues to block 640. Otherwise, the method proceeds to block 650.

At block 640, the cloud storage appliance determines whether there is a cloud file that has a threshold number of data chunks for which requests have been issued. If there is no such cloud file, the method proceeds to block 650. If a cloud file meeting this criterion is identified, the method continues to block 645, and the identified cloud file is marked for retrieval.

At block 650, the cloud storage appliance retrieves the requested data chunks and/or the unrequested cloud files from the storage cloud. In one embodiment, the requested data chunks are retrieved by performing partial file requests (e.g., HTTP partial GET requests) on the cloud files that contain the requested data chunks. The unrequested cloud files may be retrieved from the cloud storage using full file requests. The requested data chunks are retrieved in the time period. Additionally, some or all of the unrequested cloud files are retrieved in the time period. In one embodiment, all but one unrequested cloud files is retrieved in the time period. The unrequested cloud file that is not retrieved in the time period may be the cloud file that was determined at block 645. Performing partial file requests is much faster than performing full file requests. However, the storage cloud provider typically charges per input/output operation as well as per MB of data retrieved. Therefore, performing partial file requests to retrieve the requested data chunks may be associated with increased operating costs as opposed to retrieving entire cloud files.

Once the cloud files are retrieved, the cloud storage appliance divides the cloud files into unrequested data chunks at block 655. Each cloud file holds multiple (e.g., tens, hundreds or thousands) of data chunks. Each included data chunk in the cloud file is separated out. The separated out unrequested data chunks are then stored in a cloud cache along with the requested data chunks at block 660.

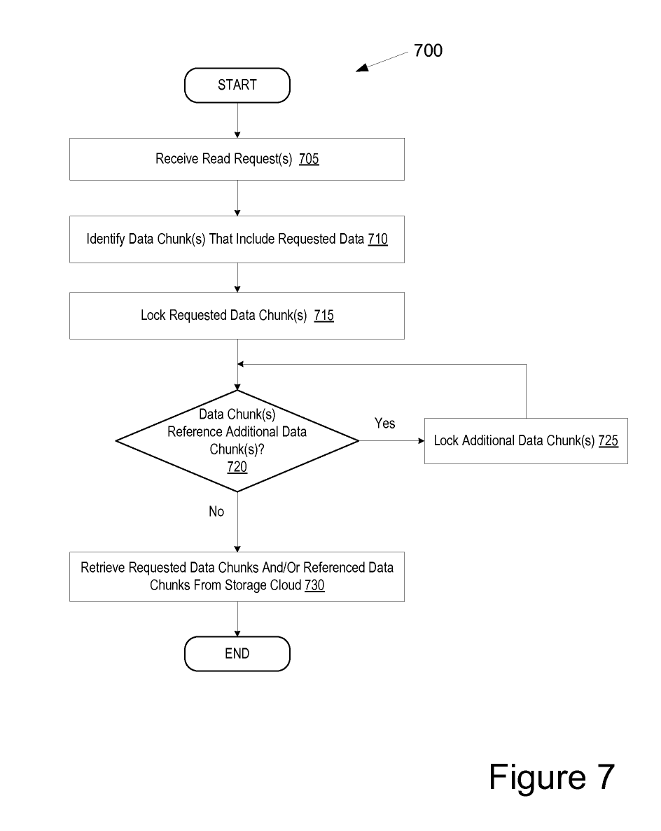

FIG. 7 is a flow diagram illustrating yet another embodiment of a method 700 for retrieving data from a storage cloud. Method 700 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 700 is performed by a cloud storage appliance (e.g., cloud storage appliance 110 of FIG. 1). Alternatively, method 700 may be performed by a cloud storage agent. Method 700 may be performed, for example, by a data fetching module running on a cloud storage appliance or cloud storage agent. For convenience, method 700 will be discussed with reference to a cloud storage appliance. However, it should be understood that method 700 may also be performed by other software and/or hardware elements.

Referring to FIG. 7, at block 705 of method 700 a cloud storage appliance receives a read request (or multiple read requests). At block 710, the cloud storage appliance identifies data chunks that include the requested data. At block 715, the cloud storage appliance places locks on the requested data chunks. Placing locks on the requested data chunks ensures that these data chunks cannot be modified by any other entities while they are being retrieved. Each data chunk may have been compressed prior to being stored in the storage cloud. The compression may include deduplication, in which portions of the data chunk are replaced with references to other data chunks stored in the storage cloud. If the requested data chunk (or chunks) references other data chunks, the method continues to block 725. Otherwise, the method proceeds to block 730.

At block 725, the cloud storage appliance locks the additional data chunk (or data chunks) that were referenced by the requested data chunks. The method then returns to block 720, and the cloud storage appliance determines whether any of the additional data chunks in turn reference any other additional data chunks. If so, the method continues to block 725. Otherwise, the method continues to block 730. This continues until the requested data chunks and all additional referenced data chunks are locked. At block 730, the cloud storage appliance then retrieves the requested data chunks and/or the referenced data chunks from the storage cloud. In one embodiment, the requested data chunks and additional data chunks are retrieved in reverse order. For example, in FIG. 4, reference chunks 497A, 497B, 498A and 498B would be retrieved before any of reference chunks 496A and 496B, which would be retrieved before requested data chunk 495.

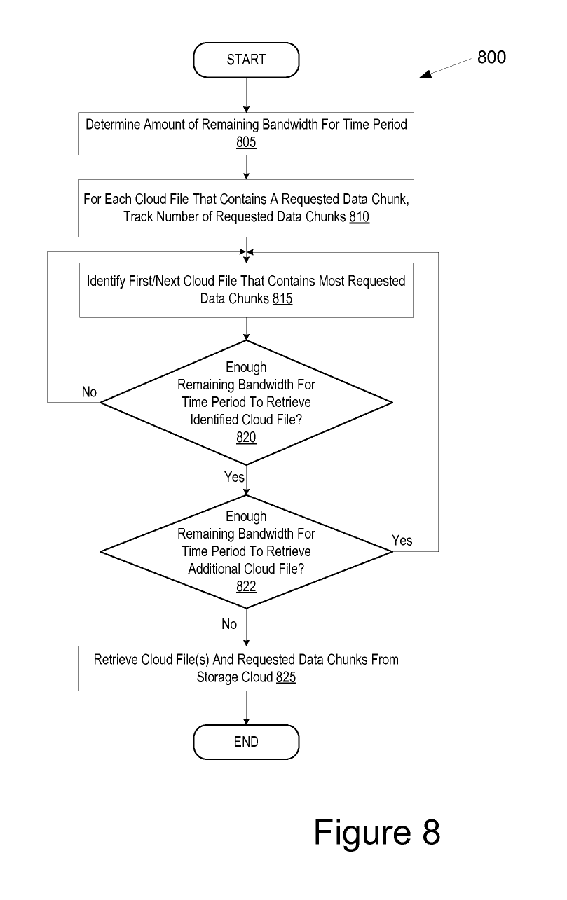

FIG. 8 is a flow diagram illustrating still yet another embodiment of a method 800 for retrieving data from a storage cloud. Method 800 may be performed by processing logic that may comprise hardware (e.g., circuitry, dedicated logic, programmable logic, microcode, etc.), software (e.g., instructions run on a processing device to perform hardware simulation), or a combination thereof. In one embodiment, method 800 is performed by a cloud storage appliance (e.g., cloud storage appliance 110 of FIG. 1). Alternatively, method 800 may be performed by a cloud storage agent. Method 800 may be performed, for example, by a data fetching module running on a cloud storage appliance or cloud storage agent. For convenience, method 800 will be discussed with reference to a cloud storage appliance. However, it should be understood that method 800 may also be performed by other software and/or hardware elements.

Referring to FIG. 8, at block 805 of method 800 a cloud storage appliance determines an amount of remaining bandwidth for a time period. At block 810, the cloud storage appliance keeps track of each cloud file that contains a requested data chunk. For each such cloud file, the cloud storage appliance tracks the number of requested data chunks that the cloud file includes. At block 815, the cloud storage appliance identifies the cloud file that contains the most requested data chunks.

At block 820, the cloud storage appliance determines whether there is enough remaining bandwidth in the time period to retrieve the identified cloud file. If there is enough remaining bandwidth in the time period, the method continues to block 822. If there is not enough remaining bandwidth in the time period, the method returns to block 815, and identifies the cloud file that includes the next most requested data chunks.

At block 822, the cloud storage appliance determines whether there is enough remaining bandwidth in the time period to retrieve any more cloud files. This may be done by comparing the remaining bandwidth to the size of the smallest cloud file. If there is enough remaining bandwidth to retrieve the identified cloud file and one or more additional cloud files, the method returns to block 815. Otherwise, the method continues to block 825. At block 825, the cloud storage appliance retrieves the cloud file (or files) and the requested data chunk (or data chunks) from the storage cloud.

Embodiments of the present invention have been described as being within or operating within a cloud storage appliance and/or cloud storage agent. However, it should be noted that in other embodiments of the present invention, certain functionalities may be moved to within the storage cloud 215. For example, an agent may be placed in the storage cloud 215 for fetching data chunks and/or cloud files from the storage cloud. Cloud storage appliances and/or cloud storage agents may send read requests to the agent in the storage cloud, and the agent may determine which data chunks to fetch and which cloud files to speculatively prefetch. The agent may fetch these from the storage cloud and send them back to the cloud storage appliance.

An agent in the storage cloud may provide some additional benefits over a standalone cloud storage appliance at the expense of additional cost. For example, such an agent can determine an amount of latency and/or bandwidth within the storage cloud as well as available network bandwidth between the storage cloud and the cloud storage appliance. If the transaction cost within the storage cloud is high, but the transaction cost over the network is low, then the agent may prefetch more cloud files to reduce the number of transactions and increase the size of each transaction. If, on the other hand, the transaction cost within the storage cloud is low, but the transaction cost over the network is high, then the agent may prefetch fewer cloud files to increase the number of transactions and decrease the size of each transaction. An agent in the storage cloud may also perform consistency checks, data mining, data searching, indexing, and other analytical operations that are improved by very high bandwidth pipes to the stored data. Since the agent is close to the data, with a high bandwidth pipe to the data, it can fetch and decompress data, then perform the data mining, searching, indexing, etc. The agent may then report results of such operations to cloud storage appliances.

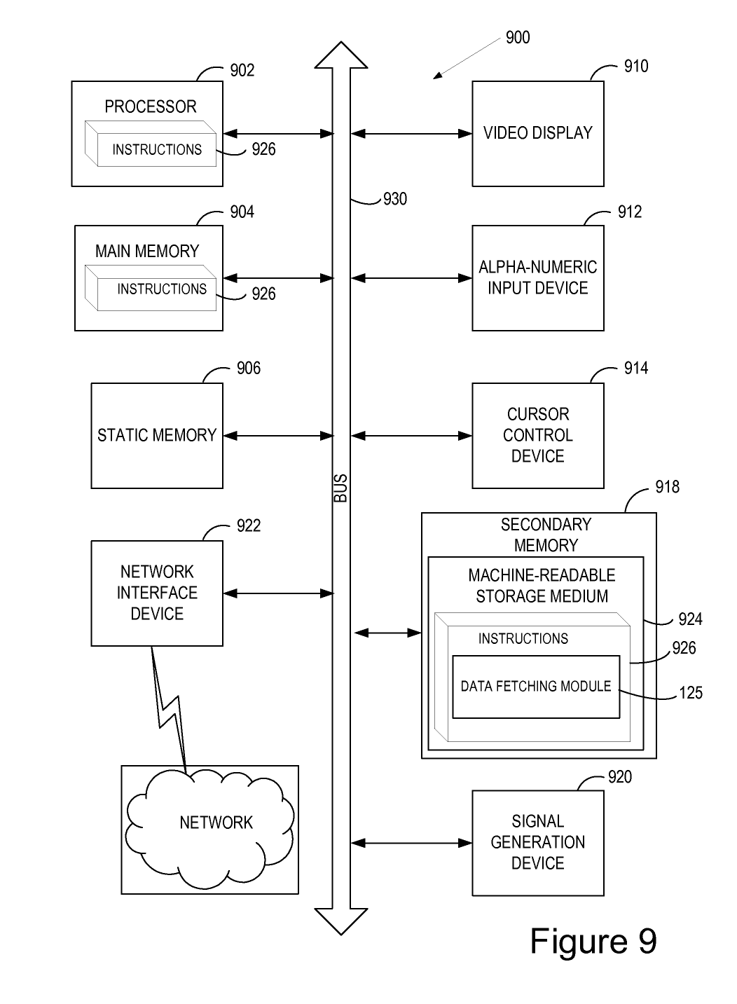

FIG. 9 illustrates a diagrammatic representation of a machine in the exemplary form of a computer system 900 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein. In one embodiment, the computer system 900 corresponds to cloud storage appliance 110 of FIG. 1. Alternatively, the computer system 900 may correspond to cloud storage appliance 205 or client 230 of FIG. 2.

The exemplary computer system 900 includes a processor 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a secondary memory 918 (e.g., a data storage device), which communicate with each other via a bus 930.

Processor 902 represents one or more general-purpose processing devices such as a microprocessor, central processing unit, or the like. More particularly, the processor 902 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 902 may also be one or more special-purpose processing devices such as an application specific integrated circuit (ASIC), a field programmable gate array (FPGA), a digital signal processor (DSP), network processor, or the like. Processor 902 is configured to execute instructions 926 (e.g., processing logic) for performing the operations and steps discussed herein.

The computer system 900 may further include a network interface device 922. The computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), and a signal generation device 920 (e.g., a speaker).

The secondary memory 918 may include a machine-readable storage medium (or more specifically a computer-readable storage medium) 924 on which is stored one or more sets of instructions 926 (e.g., software) embodying any one or more of the methodologies or functions described herein. The instructions 926 may also reside, completely or at least partially, within the main memory 904 and/or within the processing device 902 during execution thereof by the computer system 900, the main memory 904 and the processing device 902 also constituting machine-readable storage media.

The machine-readable storage medium 924 may also be used to store the data fetching module 125 of FIG. 1, and/or a software library containing methods that call the data fetching module. While the machine-readable storage medium 924 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A method comprising:
receiving one or more read requests for data stored in a storage cloud;
determining, for a time period, a total amount of bandwidth that will be used to retrieve the requested data from the storage cloud;
determining an amount of remaining bandwidth for the time period;
retrieving the requested data from the storage cloud in the time period to satisfy the one or more read requests; and
retrieving a quantity of unrequested data from the storage cloud in the time period, wherein at least a portion of the retrieved unrequested data has an increased probability of being requested in a future time period, and wherein the quantity of retrieved unrequested data is based on the amount of remaining bandwidth for the time period.

2. The method of claim 1, wherein the requested data comprises a plurality of requested data chunks, each of which is contained within a cloud file stored in the storage cloud.

3. The method of claim 2, wherein:
retrieving the plurality of data chunks comprises performing partial file requests on cloud files that contain the plurality of data chunks; and
retrieving the unrequested data comprises retrieving at least one cloud file containing one or more data chunks that have an increased probability of being requested.

4. The method of claim 3, further comprising:
determining that the at least one cloud file contains one or more data chunks that have an increased probability of being requested based on identifying a plurality of already requested data chunks contained by the at least one cloud file.

5. The method of claim 3, further comprising:
making a first determination that the at least one cloud file has at least a threshold number of data chunks that have been requested;
making a second determination that the network bandwidth is increasing or remaining steady;
making a third determination that the amount of remaining bandwidth for the time period satisfies a bandwidth threshold; and
upon making the first determination, the second determination and the third determination, retrieving the at least one cloud file.

6. The method of claim 3, further comprising:
separating the at least one cloud file into a plurality of unrequested data chunks; and
placing the plurality of unrequested data chunks in a cache.

7. The method of claim 2, further comprising:
determining additional data chunks referenced by the requested data chunks; and
retrieving the additional data chunks before retrieving the requested data.

8. The method of claim 7, further comprising:
placing the requested data chunks and the additional data chunks in a cache;
decompressing the requested data chunks using the additional data chunks;
returning the requested data chunks to a requestor; and
removing the requested data chunks and the additional data chunks from the cache upon returning the requested data chunks to the requestor.

9. The method of claim 1, wherein the requested data is retrieved from the storage cloud using an HTTP partial GET command and the unrequested data is retrieved from the storage cloud using a standard HTTP GET command.

10. A computer readable storage medium including instructions that, when executed by a processing device, cause the processing device to perform a method comprising:
receiving one or more read requests for data stored in a storage cloud;
determining, for a time period, a total amount of bandwidth that will be used to retrieve the requested data from the storage cloud;
determining an amount of remaining bandwidth for the time period;
retrieving the requested data from the storage cloud in the time period to satisfy the one or more read requests; and
retrieving a quantity of unrequested data from the storage cloud in the time period, wherein at least a portion of the retrieved unrequested data has an increased probability of being requested in a future time period, and wherein the quantity of retrieved unrequested data is based on the amount of remaining bandwidth for the time period.

11. The computer readable storage medium of claim 10, wherein the requested data comprises a plurality of requested data chunks, each of which is contained within a cloud file stored in the storage cloud.

12. The computer readable storage medium of claim 1, wherein:
retrieving the plurality of data chunks comprises performing partial file requests on cloud files that contain the plurality of data chunks; and
retrieving the unrequested data comprises retrieving at least one cloud file containing one or more data chunks that have an increased probability of being requested.

13. The computer readable storage medium of claim 12, the method further comprising:
determining that the at least one cloud file contains one or more data chunks that have an increased probability of being requested based on identifying a plurality of already requested data chunks contained by the at least one cloud file.

14. The computer readable storage medium of claim 12, the method further comprising:
making a first determination that the at least one cloud file has at least a threshold number of data chunks that have been requested;
making a second determination that the network bandwidth is increasing or remaining steady;
making a third determination that the amount of remaining bandwidth for the time period satisfies a bandwidth threshold; and
upon making the first determination, the second determination and the third determination, retrieving the at least one cloud file.

15. The computer readable storage medium of claim 12, the method further comprising:
separating the at least one cloud file into a plurality of unrequested data chunks; and
placing the plurality of unrequested data chunks in a cache.

16. The computer readable storage medium of claim 11, the method further comprising:
determining additional data chunks referenced by the requested data chunks; and
retrieving the additional data chunks before retrieving the requested data.

17. The computer readable storage medium of claim 16, the method further comprising:
placing the requested data chunks and the additional data chunks in a cache;
decompressing the requested data chunks using the additional data chunks;
returning the requested data chunks to a requestor; and
removing the requested data chunks and the additional data chunks from the cache upon returning the requested data chunks to the requestor.

18. The computer readable storage medium of claim 10, wherein the requested data is retrieved from the storage cloud using an HTTP partial GET command and the unrequested data is retrieved from the storage cloud using a standard HTTP GET command.

19. A computing device, comprising:
a memory to store instructions for a data fetching module; and
a processing device to execute the instructions, wherein the instructions cause the processing device to:
determine, for a time period, a total amount of bandwidth that will be used to retrieve requested data from a storage cloud after receiving one or more read requests for the requested data stored in the storage cloud;
determine an amount of remaining bandwidth for the time period;
retrieve the requested data from the storage cloud in the time period to satisfy the one or more read requests; and
retrieve a quantity of unrequested data from the storage cloud in the time period, wherein at least a portion of the retrieved unrequested data has an increased probability of being requested in a future time period, and wherein the quantity of retrieved unrequested data is based on the amount of remaining bandwidth for the time period.

20. The computing device of claim 19, wherein:
the requested data comprises a plurality of requested data chunks, each of which is contained within a cloud file stored in the storage cloud.
retrieving the plurality of data chunks comprises performing partial file requests on cloud files that contain the plurality of data chunks; and
retrieving the unrequested data comprises retrieving at least one cloud file containing one or more data chunks that have an increased probability of being requested.

21. The computing device of claim 20, further comprising the instructions to cause the processing device to:
determine that the at least one cloud file contains one or more data chunks that have an increased probability of being requested based on identifying a plurality of already requested data chunks contained by the at least one cloud file.

22. The computing device of claim 20, further comprising the instructions to cause the processing device to:
separate the at least one cloud file into a plurality of unrequested data chunks; and
place the plurality of unrequested data chunks in a cache.

23. The computing device of claim 20, further comprising the instructions to cause the processing device to:
determine additional data chunks referenced by the requested data chunks; and
retrieve the additional data chunks before retrieving the requested data.

24. The computing device of claim 23, further comprising:
a cache;
wherein the instructions cause the processing device to place the requested data chunks and the additional data chunks in the cache, to decompress the requested data chunks using the additional data chunks, to return the requested data chunks to a requestor, and to remove the requested data chunks and the additional data chunks from the cache upon returning the requested data chunks to the requestor.
